(19) United States
(12) Patent Application Publication
(10) Pub. No.: US 2011/0075573 A1
(43) Pub. Date: Mar. 31, 2011

(54) RING NETWORK SYSTEM AND COMMUNICATION PATH CONTROL METHOD

(75) Inventors: Yasunori Saigusa, Yokohama (JP); Satoshi Shimizu, Yokohama (JP); Takayuki Nakagawa, Tokyo (JP); Shinya Motoyama, Tokyo (JP)

(73) Assignee: Hitachi, Ltd.

(21) Appl. No.: 12/841,968

(22) Filed: Jul. 22, 2010

(30) Foreign Application Priority Data
Sep. 29, 2009 (JP) 2009-224930

(51) Int. Cl. H04L 12/26

(52) U.S. Cl. 370/248

(57) ABSTRACT

A control node includes: a monitoring packet transmission section for transmitting a monitoring packet; a monitoring packet reception section for receiving a monitoring packet; an adjustment section for selecting a redundant node from a non-control nodes; a packet generation section for generating a setup packet for specifying the redundant node out of the non-control nodes in accordance with information about the redundant node selected by the adjustment section; and a packet transmission section for transmitting the setup packet to the non-control node. The non-control node includes a control section that acquires information about the traffic upon receiving the monitoring packet, transmits a monitoring packet after acquisition of the traffic, and specifies the non-control node as the redundant node based on information about the redundant node contained in the setup packet upon receiving the setup packet.

### CLAIM OF PRIORITY

The present application claims priority from Japanese application serial no. JP2009-224930, filed on Sep. 29, 2009, the content of which is hereby incorporated by reference into this application.

### BACKGROUND OF THE INVENTION

1. Field of the Invention

The present invention relates to a ring network system for solving redundancy of Ethernet (registered trademark) communication paths. More particularly, the invention relates to a ring network system and a communication path control method for traffic dispersion on a VLAN (Virtual Local Area Network) basis.

2. Description of Related Art

A conventional Ethernet system often uses a ring network topology containing annularly connected multiple Ethernet switches so as to make communication paths redundant.

The ring network topology is provided with two redundant paths according to clockwise and counterclockwise rotations along the ring. For example, let us suppose that an error occurs at a given point on the ring. Normally, one of the clockwise and counterclockwise routes is blocked. When the operating route is disconnected, the blocked route is connected to provide changeover to the redundant route. The technologies described in JP-A-2005-210279, JPA-2005-260927, and Japanese Patent No. 3938037 provide such communication path changeover.

As another example, ITU-T Recommendation G.8032/Y.1344 Ethernet Ring Protection Switching describes the ring network in addition to the technologies described in JP-A-2005-210279, JP-A-2005-260927, and Japanese Patent No. 3938037. The ring network forms paths between Ethernet switches included in the ring network. The ring network blocks one of the paths on a VLAN basis to provide a redundant system. Such a normally blocked link is referred to as a ring redundant link.

FIG. 8 schematically shows a normal state of the ring network described in ITU-T Recommendation G.8032/Y.1344 Ethernet Ring Protection Switching. As shown in FIG. 8, Ethernet switches (nodes) 1 through 4 are connected with links 12, 23, 34, and 41. According to the example in FIG. 8, the link 41 functions as a redundant link and prevents a loop by blocking traffic between the nodes 1 and 4 in the normal state. FIG. 9 shows occurrence of an error at a link in the ring network shown in FIG. 8. The example in FIG. 9 shows that an error occurs at the link 23. When such error (link error) occurs, a control packet is transmitted to the nodes 1 and 4 at both ends of the redundant link. The transmission releases the block state of the link 41 as the ring redundant link.

In this case, the nodes 2 and 3 at both ends of the link 23 blocks this link to prevent the traffic. Each node initializes an FDB (Filtering DataBase) to reconfigure route information about the traffic. The reconfiguration changes the traffic communication route over to the redundant route.

According to the above-mentioned ring network, a position for installing the ring redundant link in the ring network determines a communication path for the traffic during normal operations. A system manager of the ring network defines the ring redundant link at a position capable of most efficiently suppressing the network traffic and configures the position in the FDB for each node, for example. Effective communication is available by changing the defined position for the ring redundant link depending on the system usage.

Such configuration or changeover requires recognition of the traffic for each link and may overburden users such as system administrators.

### SUMMARY OF THE INVENTION

The present invention has been made in consideration of the foregoing. It is therefore an object of the present invention to provide an Ethernet ring network system and a communication path control method capable of positioning a ring redundant link without burdening users.

In order to achieve the above-mentioned object, an Ethernet ring network system according to the invention is embodied as a ring network system in which multiple nodes each having at least two ports are connected to each other in a ring topology. The nodes include a control node and non-control nodes. The control node controls a communication path between the nodes and includes: a monitoring packet transmission section for transmitting a monitoring packet for monitoring traffic of one of the non-control nodes to the non-control node other than a control node; a monitoring packet reception section for receiving a monitoring packet that is transmitted from the monitoring packet transmission section and is supplied with information about the traffic by the non-control node; an adjustment section for selecting a redundant node from the non-control nodes based on a monitoring packet that is received by the monitoring packet reception section and is supplied with information about the traffic; a packet generation section for generating a setup packet for specifying the redundant node out of the non-control nodes in accordance with information about the redundant node selected by the adjustment section; and a packet transmission section for transmitting the setup packet generated by the packet generation section to the non-control node. The non-control node includes a control section that acquires information about the traffic upon receiving the monitoring packet transmitted by the control node, transmits a monitoring packet after acquisition of the traffic, and specifies the non-control node as the redundant node based on information about the redundant node contained in the setup packet upon receiving a setup packet.

The present invention is concerned with a communication path control method used for the above-mentioned ring network system.

The invention can position a ring redundant link without burdening users.

### BRIEF DESCRIPTION OF THE DRAWINGS

FIG. 1 shows a configuration of an Ethernet ring network system 1000 according to an embodiment of the invention;

FIG. 2 shows a functional configuration of a control node in FIG. 1;

FIG. 3 exemplifies a specific configuration of a setup packet generated from an RPL control packet generation section;

FIG. 4 exemplifies a configuration of a monitoring packet for monitoring traffic over a ring;

FIG. 5 is a flowchart showing a process for a control node to transmit a clockwise monitoring packet and a counterclockwise monitoring packet;

FIG. 6 is a flowchart showing a process for a non-control node to receive a clockwise monitoring packet and a counterclockwise monitoring packet;

FIG. 7 is a flowchart showing a process for a non-control node to receive a setup packet;

FIG. 8 schematically shows a normal state of a conventional ring network; and

FIG. 9 shows occurrence of an error on a link in the ring network shown in FIG. 8.

### DETAILED DESCRIPTION OF THE PREFERRED EMBODIMENTS

An embodiment of the ring network system and the communication path control method according to the invention will be described in further detail with reference to the accompanying drawings.

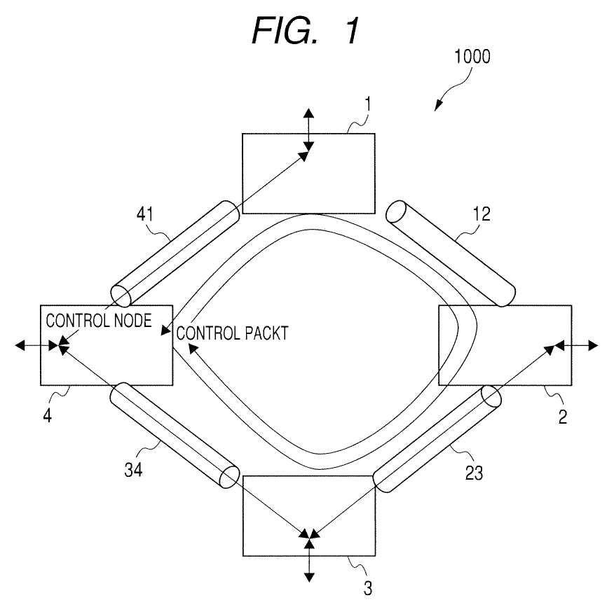

FIG. 1 shows a configuration of an Ethernet ring network system 1000 according to the embodiment of the invention. As shown in FIG. 1, the Ethernet ring network system 100 includes non-control Ethernet switches 1 through 3, a control Ethernet switch 4, and links 12, 23, 34, and 41 for connection between the non-control Ethernet switches and the control Ethernet switch.

In the following description, the non-control Ethernet switch may be referred to as a non-control node. The control Ethernet switch may be referred to as a control node. When a redundant communication path is used, the non-control node may be referred to as a redundant node as will be described later. The link 12 is equivalent to a LAN (Local Area Network) line, for example.

The non-control nodes 1 through 3 include switching hubs each having multiple ports, for example. Each of the non-control nodes 1 through 3 receives communication data such as a packet transmitted from an adjacent non-control node or the control node 4 and transmits communication data to the other non-control nodes 1 through 3 or the control node 4.

For example, the non-control node 1 receives a packet from outside the Ethernet ring network system 1000, references path information contained in the received packet, and transmits the packet to the non-control node 2 or the control node 4. The example in FIG. 1 shows that the non-control node 1 transmits a packet to the control node 4. The non-control node 1 or the like includes an arithmetic device (not shown) such as a CPU (Central Processing Unit) that controls the transmission and reception.

The control node 4 includes a switching hub having multiple ports. The control node 4 receives communication data such as a packet transmitted from the adjacent non-control nodes 1 through 3 and transmits communication data to these nodes. The control node 4 bidirectionally or unidirectionally transmits a control packet to the Ethernet ring network system 1000 (hereafter also referred to as a ring) and receives the control packet that traveled the ring. The control node 4 analyzes or otherwise processes the received control packet.

The control packet generically signifies the setup packet and the monitoring packet to be described later. The contents of these packets will be described along with the functional configuration of the control node 4. Packets other than control packets transmitted or received by the non-control node 1 may also be referred to as non-control packets in the following description so as to be distinguished from control packets transmitted from the control node 4.

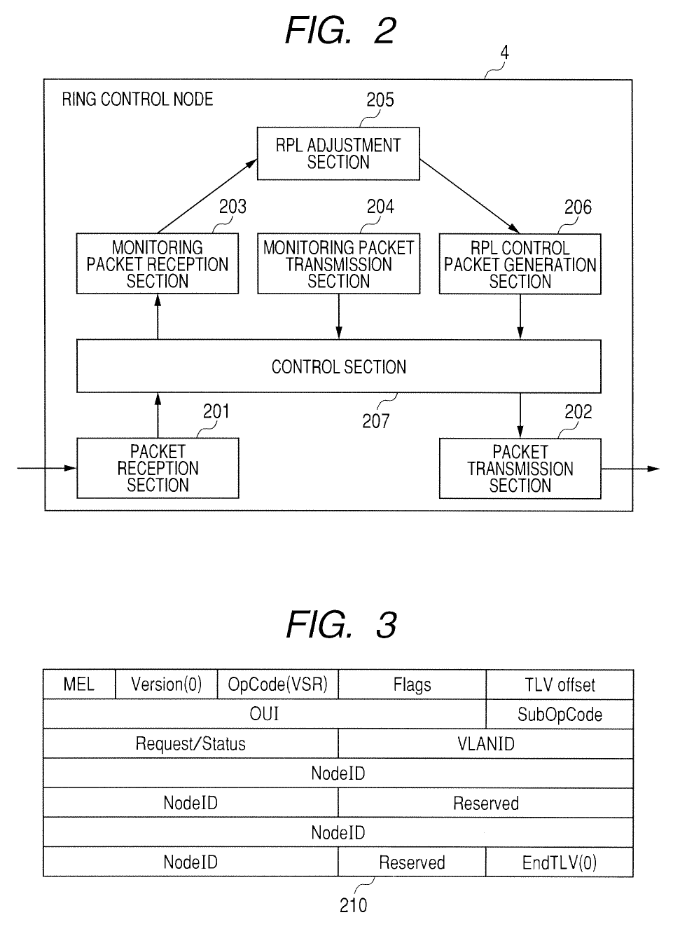

FIG. 2 shows a functional configuration of the control node 4. As shown in FIG. 2, the control node 4 includes a packet reception section 201, a packet transmission section 202, a monitoring packet reception section 203, a monitoring packet transmission section 204, an RPL adjustment section 205, an RPL control packet generation section 206, and a control section 207.

The packet reception section 201 receives a packet (non-control packet) transmitted from an adjacent non-control node. The packet transmission section 202 transmits a packet (non-control packet) received from an adjacent non-control node to another adjacent non-control node.

When the monitoring packet transmission section 204 (to be described) transmits a monitoring packet (to be described), the monitoring packet reception section 203 receives the monitoring packet from an adjacent non-control node. The monitoring packet transmission section 204 transmits a monitoring packet (to be described) generated from the RPL control packet generation section 206 to an adjacent non-control node.

The RPL adjustment section 205 references a monitoring packet (to be described) and determines a redundant link position in the Ethernet ring network system 1000.

The RPL control packet generation section 206 generates a setup packet for configuring the redundant link position determined by the RPL adjustment section 205.

The control section 207 includes an arithmetic device such as a CPU (Central Processing Unit) to control operations of the above-mentioned sections.

FIG. 3 exemplifies a specific configuration of a setup packet 210 generated from the RPL control packet generation section 206. As shown in FIG. 3, the setup packet contains VLANID for identifying VLAN and a node ID of a non-control node adjacent to the control node.

As elements of the setup packet 210 in FIG. 3, MEL provides information for identifying a maintenance level of the control node 4 and indicates a maintenance entity to which an OAM frame belongs. Version is equivalent to a standard version to which OAM packets conform. The example in FIG. 2 shows that Version is set to 0.

Opcode indicates the message type. The example shows Opcode=51, i.e., a vendor-specific VSM message. Flags indicates a flag used by the message and is set to zero as an initial value because the embodiment uses no flags.

A TLV offset is provided for TLV as information appended to a message. The example assumes the offset up to EndTLV(0x00) because no TLV is supplied to the message. OUI is used in an organization using VSM and provides an ID such as an organization code for uniquely identifying the organization. The example assumes an initial value to be 0x000000. Sub0 pCode provides a code indicating the meaning of the remaining VSM. The example assumes a code indicating an RPL control request.

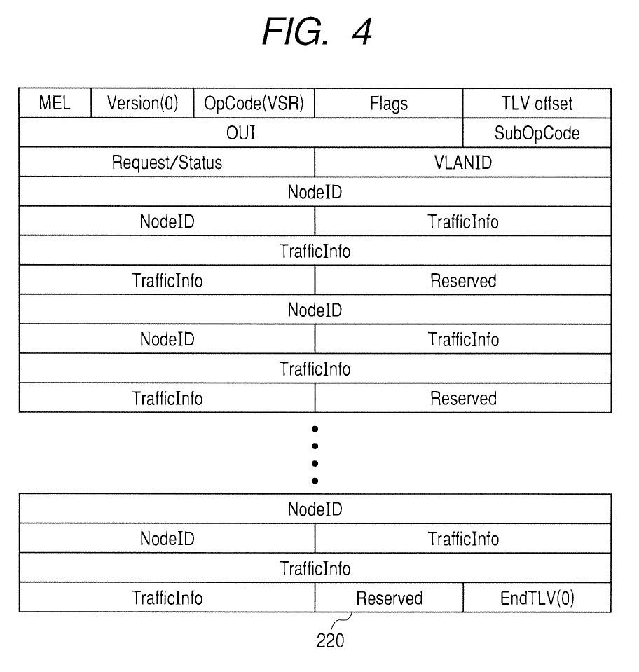

FIG. 4 exemplifies a configuration of a monitoring packet 220 for monitoring traffic over the ring. As shown in FIG. 4, the monitoring packet 220 contains VLANID and traffic information. VLANID specifies VLAN targeted for collection of information (traffic information) indicating the state of traffic over the network. The traffic information is collected by nodes included in the VLAN specified by VLANID.

Specifically, MEL, OAM, and the other items of the monitoring packet 220 in FIG. 4 are the same as those in the setup packet 210. Except Sub0 pCode, these items are assigned the same values as for the items of the setup packet 210. Sub0 pCode is assigned the code indicating a traffic information request.

The control node 4 transmits a monitoring packet. For example, the non-control node 1 receives the transmitted monitoring packet and supplies it with information about VLAN, i.e., the traffic information. According to the configuration in FIG. 1, for example, the control node 4 transmits a monitoring packet and thereafter receives the monitoring packet via the non-control nodes 1 through 3. The monitoring packet is supplied with the traffic information at the non-control nodes. The control node 4 transmits a monitoring packet to the non-control nodes formed in accordance with a ring topology. The non-control nodes add traffic information to the monitoring packet. As a result, the control node can keep track of traffic states over the ring.

According to the embodiment, the monitoring packet transmission section 204 clockwise or counterclockwise transmits the monitoring packet 220 generated by the RPL packet generation section 206 so that the control node 4 uses the monitoring packet reception section 203 to periodically keep track of traffic states. The monitoring packet reception section 203 may thereafter receive the monitoring packet 220 supplied with the traffic information via the non-control node 1, for example. In such case, the RPL adjustment section 205 references the traffic information contained in the monitoring packet 220 and analyzes a traffic state of the link 12 included in the Ethernet ring network system 1000, for example.

For example, the non-control node 1 uses a VLAN-based reception counter (not shown) at a port for receiving non-control packets and a VLAN-based transmission counter (not shown) at a port for transmitting non-control packets to count values for non-control packets. The RPL adjustment section 205 collects the count values via the packet reception section 201. The RPL reception section 205 then calculates a difference between the transmission counter value and the reception counter value (transmission counter value minus reception counter value), i.e., the traffic passing through the non-control node 1, for example.

The calculated value as a differential count value is equivalent to the traffic supplied from the non-control node. The control node 4 clockwise transmits a monitoring packet (hereafter referred to as a clockwise monitoring packet) in the direction from the control node 4 to the control node 1 according to the example in FIG. 1. The control node 4 counterclockwise transmits a monitoring packet (hereafter referred to as a counterclockwise monitoring packet) in the direction from the control node 4 to the control node 3 according to the example in FIG. 1. The RPL adjustment section 205 adjusts the RPL position so as to equalize the values for the clockwise and counterclockwise control packets.

For example, the RPL adjustment section 205 compares an accumulated value of the traffic for the clockwise monitoring packet with that for the counterclockwise monitoring packet. When the clockwise traffic is larger, the RPL adjustment section 205 shifts the ring redundant link (redundant node) to the right. When the counterclockwise traffic is larger, the RPL adjustment section 205 shifts the ring redundant link to the left. The RPL adjustment section 205 stores the ring redundant link setting in memory (not shown), for example. Such algorithm is previously stored as a ring redundant link adjustment algorithm in a storage medium such as the memory (not shown).

The RPL control packet generation section 206 then generates a setup packet for configuring the stored ring redundant link. The RPL control packet generation section 206 transmits the setup packet to the non-control node via the packet transmission section 202. The non-control node references the received setup packet and determines whether or not the configuration is targeted for the local node. When the configuration is not targeted for the local node, the non-control node determines whether or not the local node is configured at both ends of the ring redundant link.

The non-control node releases the block state upon determining that the local node is configured to belong to both nodes for the redundant link. The non-control node determines whether or not the setting for the received setup packet is equivalent to that for the local node. The non-control node enables a new block state upon determining that the setting for the received setup packet is equivalent to that for the local node.

The non-control node releases its possibly blocked port upon determining that the setting for the received setup packet is not equivalent to that for the local node. When the port of the local node is blocked or unblocked, each node initializes the FDB to reconfigure the route. This makes it possible to adjust the position of the redundant link in the ring in accordance with the traffic and optimize resources for the entire Ethernet ring network system 1000.

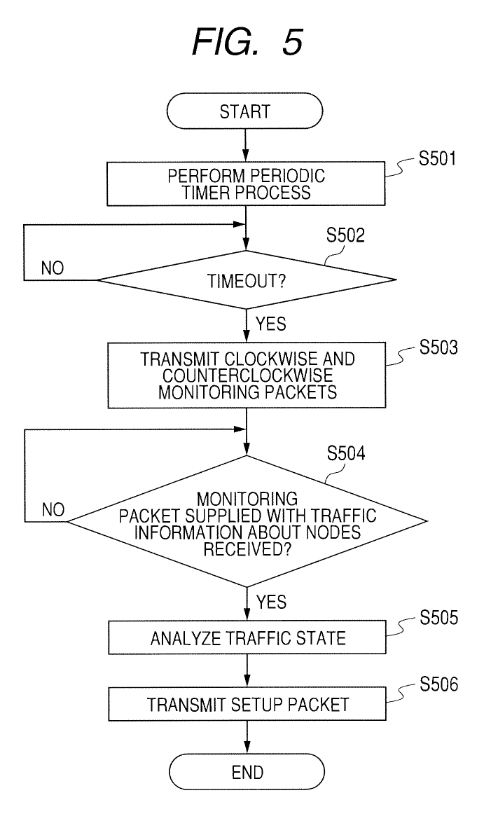

The following describes processes performed in the Ethernet ring network system 1000. FIG. 5 is a flowchart showing a process for the control node 4 to transmit a clockwise monitoring packet and a counterclockwise monitoring packet in the Ethernet ring network system 1000.

As shown in FIG. 5, the control node 4 uses a timer (not shown) to perform a periodic timer process for periodical time keeping (Step S501). The control section 207 determines whether or not the time measured by the timer exceeds a predetermined time interval to case a timeout condition (Step S502).

The control section 207 may determine that the time measured by the timer does not indicate the timeout condition (No at Step S502). In this case, the process waits. The control section 207 may determine that the time measured by the timer indicates the timeout condition (Yes at Step S502). In this case, the monitoring packet transmission section 204 transmits a clockwise monitoring packet and a counterclockwise monitoring packet to the adjacent non-control node (Step S503). The monitoring packet reception section 203 then determines whether or not it receives a clockwise monitoring packet and a counterclockwise monitoring packet supplied with traffic information about the non-control nodes (Step S504).

The monitoring packet reception section 203 may determine that it does not receive a clockwise monitoring packet and a counterclockwise monitoring packet supplied with traffic information about the non-control nodes (No at Step S504). In this case, the process waits.

The monitoring packet reception section 203 may determine that it receives a clockwise monitoring packet and a counterclockwise monitoring packet supplied with traffic information about the non-control nodes (Yes at Step S504). In this case, the control node 4 references the traffic information contained in the clockwise monitoring packet and counterclockwise monitoring packet received and analyzes traffic states of the non-control nodes (Step S505).

Upon completion of Step S505, the RPL control packet generation section 206 generates a setup packet based on the traffic state of the non-control node and transmits the setup packet to the non-control node via the packet transmission section 202 (Step S506). Completing Step S506 terminates the entire process in FIG. 5.

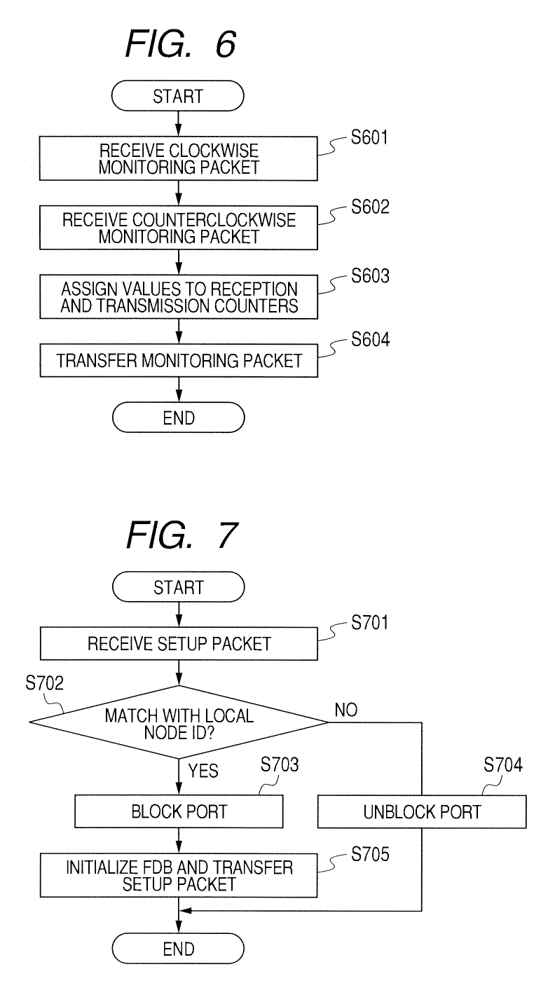

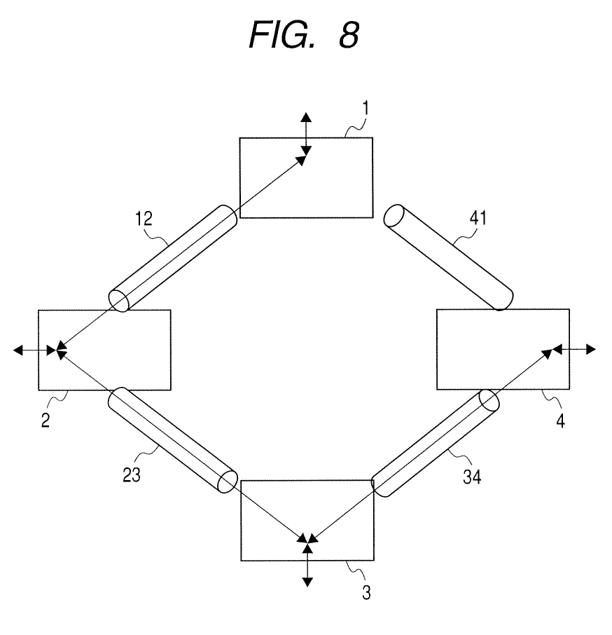

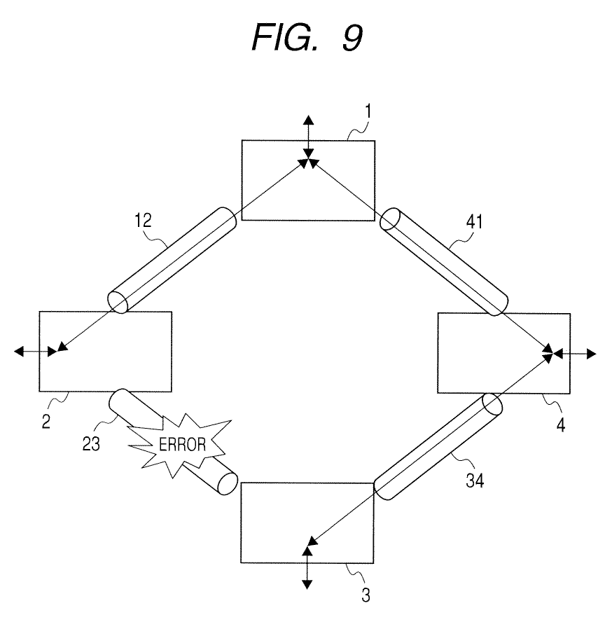

The following describes a process for the non-control node to receive monitoring packets from the control node 4. FIG. 6 is a flowchart showing a process for the non-control node to receive a clockwise monitoring packet and a counterclockwise monitoring packet.

As shown in FIG. 6, the non-control node receives the clockwise monitoring packet (Step S601) and the counterclockwise monitoring packet (Step S602) transmitted from the control node 4. A reception counter (not shown) counts received monitoring packets. A transmission counter counts monitoring packets that transmit received monitoring packets. The non-control node assigns the counted values to the respective counters (Step S603). The non-control node transfers the clockwise monitoring packet and the counterclockwise monitoring packet received from the control node 4 to an adjacent non-control node (Step S604). Terminating Step S604 terminates the entire process in FIG. 6.

The following describes a process for the non-control node to receive a setup packet from the control node 4. FIG. 7 is a flowchart showing the process for the non-control node to receive a setup packet.

As shown in FIG. 7, the non-control node receives a setup packet (Step S701). The non-control node references the node ID and determines whether or not the received setup packet is targeted for the local node (Step S702).

The non-control node may determine that the received setup packet is targeted for the local node (Yes at Step S702). In this case, the non-control node blocks its own port (Step S703). The non-control node may determine that the received setup packet is not targeted for the local node (No at Step S702). In this case, the non-control node releases its blocked port when the port is blocked (Step S704)

When Step S703 or S704 terminates, the non-control node initializes the FDB and transfers the setup packet to an adjacent non-control node (Step S705). Terminating Step S705 terminates the entire process in FIG. 7.

The ring network system 1000 includes multiple nodes that have each at least two ports and are connected to each other based on a ring topology. The nodes include the control node 4 and the other non-control nodes such as the non-control node 1. The control node 4 controls communication paths between the nodes. The control node 4 allows the monitoring packet transmission section 204 to transmit a monitoring packet to the non-control nodes for monitoring traffic of these nodes. The monitoring packet reception section 203 receives the monitoring packet that is transmitted by the monitoring packet transmission section 204 and is supplied with information about the traffic from the non-control nodes. The RPL adjustment section 205 selects a redundant node from the non-control nodes based on the monitoring packet that is received by the monitoring packet reception section 203 and is supplied with the information about the traffic. The RPL control packet generation section 206 generates a setup packet for selecting a redundant node from the non-control nodes based on the redundant node information supplied from the RPL adjustment section 205. The packet transmission section 202 transmits the setup packet generated from the RPL control packet generation section 206 to the non-control nodes. Upon receiving the monitoring packet transmitted from the control node 4, the non-control node acquires the information about the traffic and transmits the monitoring packet after the traffic acquisition. Upon receiving the setup packet, the non-control node configures itself as a redundant node based on the redundant node information contained in the setup packet. It is possible to position a ring redundant link without burdening users. Specifically, the ring redundant link can be automatically configured using an optimum one of links belonging to the ring topology in accordance with the ring traffic. This makes it possible to greatly alleviate the burden on users of system operations.

The present invention is not limited to the above-mentioned embodiment but may be otherwise variously embodied in various modifications of the constituent elements within the spirit and scope of the invention. Various versions of the invention may be available by appropriately combining the constituent elements disclosed in the above-mentioned embodiment. For example, some constituent elements may be eliminated from all the constituent elements of the embodiment. Constituent elements of different embodiments may be appropriately combined.

What is claimed is:

1. A ring network system in which a plurality of nodes each having at least two ports is connected to each other in a ring topology,
wherein the nodes include a control node and non-control nodes;
wherein the control node controls a communication path between the nodes and includes:
a monitoring packet transmission section for transmitting a monitoring packet for monitoring traffic of one of the non-control nodes to the non-control node other than a control node;
a monitoring packet reception section for receiving a monitoring packet that is transmitted from the monitoring packet transmission section and is supplied with information about the traffic by the non-control node;
an adjustment section for selecting a redundant node from the non-control nodes based on a monitoring packet that is received by the monitoring packet reception section and is supplied with information about the traffic;
a packet generation section for generating a setup packet for specifying the redundant node out of the non-control nodes in accordance with information about the redundant node selected by the adjustment section; and
a packet transmission section for transmitting the setup packet generated by the packet generation section to the non-control node; and
wherein the non-control node includes:
a control section that acquires information about the traffic upon receiving the monitoring packet transmitted by the control node, transmits a monitoring packet after acquisition of the traffic, and specifies the non-control node as the redundant node based on information about the redundant node contained in the setup packet upon receiving the setup packet.

2. The ring network system according to claim 1,
wherein the adjustment section selects a redundant node from the non-control nodes by counting a difference in traffic passing through the non-control node from information about the traffic contained in the monitoring packet received by the monitoring packet reception section.

3. The ring network system according to claim 2,
wherein the adjustment section selects a redundant node from the non-control nodes by counting a difference in traffic passing through the non-control node in different directions.

4. The ring network system according to claim 1,
wherein the adjustment section selects the redundant node from the non-control nodes on a VLAN (Virtual Local Area Network) basis.

5. The ring network system according to claim 2,
wherein the adjustment section selects the redundant node from the non-control nodes on a VLAN (Virtual Local Area Network) basis.

6. A communication path control method applicable to a ring network system in which a plurality of nodes each having at least two ports is connected to each other in a ring topology, the method comprising:
a first monitoring packet transmission step of transmitting a monitoring packet for monitoring traffic of a non-control node to the non-control node other than a control node for controlling a communication path between the nodes;
a second monitoring packet transmission step of acquiring information about the traffic upon receiving the monitoring packet transmitted by the control node and transmitting a monitoring packet after acquisition of the traffic;
a monitoring packet reception step of receiving a monitoring packet that is transmitted at the second monitoring packet transmission step and is supplied with information about the traffic by the non-control node;
a an adjustment step of selecting a redundant node from the non-control nodes based on a monitoring packet that is received at the monitoring packet reception step and is supplied with information about the traffic;
a packet generation step of generating a setup packet for specifying the redundant node out of the non-control nodes in accordance with information about the redundant node selected at the adjustment step);
a transmission step of transmitting the setup packet generated at the packet generation step to the non-control node; and
a control step of specifying the non-control node as the redundant node based on information about the redundant node contained in the setup packet upon receiving the setup packet.

7. The communication path control method according to claim 6,
wherein the adjustment step selects a redundant node from the non-control nodes by retrieving a difference in traffic passing through the non-control node from information about the traffic contained in the monitoring packet received at the monitoring packet reception step.

8. The communication path control method according to claim 7,
wherein the adjustment step selects a redundant node from the non-control nodes by counting a difference in traffic passing through the non-control node in different directions.

9. The communication path control method according to claim 6,
wherein the adjustment step selects the redundant node from the non-control nodes on a VLAN (Virtual Local Area Network) basis.

10. The communication path control method according to claim 7,
wherein the adjustment step selects the redundant node from the non-control nodes on a VLAN (Virtual Local Area Network) basis.
